(19) United States
(12) Patent Application Publication
(10) Pub. No.: US 2017/0023361 A1
(43) Pub. Date: Jan. 26, 2017

(54) ELECTRONIC APPARATUS AND ALTITUDE CALCULATION METHOD

(71) Applicant: SEIKO EPSON CORPORATION, Tokyo (JP)

(72) Inventors: Fumikazu SANO, Matsumoto-shi (JP); Kazuhiko TSUCHIMOTO, Suwa-shi (JP)

(73) Assignee: SEIKO EPSON CORPORATION, Tokyo (JP)

(21) Appl. No.: 15/217,859

(22) Filed: Jul. 22, 2016

(30) Foreign Application Priority Data
Jul. 24, 2015 (JP) 2015-146910

(51) Int. Cl. G01C 5/06

(52) U.S. Cl. CPC G01C 5/06

(57) ABSTRACT

An electronic apparatus includes a barometric sensor that detects the barometric pressure, a receiver that receives a positioning signal from a positioning satellite, a memory that memorizes in advance information representing the relationship between the latitude and the air temperature, and a processor that uses the barometric pressure, latitude calculated based on the positioning signal, and the information to calculate the altitude.

### CROSS-REFERENCE

This application claims priority to Japanese Patent Application No. 2015-146910, filed Jul. 24, 2015, the entirety of which is hereby incorporated by reference.

### BACKGROUND

1. Technical Field

The present invention relates to an electronic apparatus, an altitude calculation program, and an altitude calculation method.

2. Related Art

In mountain climbing and other activities, a barometric altimeter is widely used to allow a user to recognize the current altitude. A barometric altimeter estimates the current altitude by applying an actually measured barometric pressure to a conversion equation (altitude measurement formula) based on the fact that the higher the altitude of a point, the lower the barometric pressure.

However, since parameters of the conversion equation can only be used under the condition that the weather condition is fixed, the barometric-altitude measurement needs to be calibrated, for example, at a fixed frequency, such as every one hour, (or whenever the calibration needs to be performed).

In the present specification, altitude measurement using a barometric sensor is referred to as “barometric-altitude measurement,” and setting or adjustment of conversion characteristics (conversion parameters) in accordance with which an output from the barometric sensor is converted into the altitude is referred to as “calibration of barometric-altitude measurement,” “calibration of barometric-altitude conversion,” “calibration of converter,” or “calibration,” as appropriate.

In the calibration, the air temperature at a point where the barometric-altitude measurement is performed or the air temperature at the sea level is typically used. JP-A-2008-241467 discloses a mobile terminal using an air temperature delivered from a weather information server over a network and a mobile terminal to which a user inputs an air temperature detected with another apparatus.

However, each of the mobile terminals, which is required to be connected to the network or required to prompt a user to input a value, cannot properly perform the calibration in a situation in which the mobile terminal cannot be connected to the network, for example, during mountain climbing or in a situation in which the user cannot operate the mobile terminal, resulting in a decrease in accuracy in the barometric-altitude measurement.

It is conceivable to incorporate a temperature sensor in each of the mobile terminals for air temperature measurement, but the fact that the temperature sensor incorporated in the mobile terminal is strongly affected by the user's body temperature makes it difficult to accurately measure the air temperature at the point where the mobile terminal is present.

### SUMMARY

An advantage of some aspects of the invention is to provide an electronic apparatus, an altitude calculation method, and an altitude calculation program requiring no network connection, user input, or air temperature measurement but capable of suppressing a decrease in accuracy in barometric-altitude measurement.

The invention can be implemented by the following aspects or application examples.

### APPLICATION EXAMPLE 1

An electronic apparatus according to this application example includes a barometric sensor that detects barometric pressure, a receiver that receives a positioning signal from a positioning satellite, a memory that memorizes in advance information representing a relationship between latitude and air temperature, and a processor that uses the barometric pressure, latitude calculated based on the positioning signal, and the information to calculate altitude.

Since the memory memorizes in advance the information representing the relationship between the latitude and the air temperature, the processor can reflect the air temperature determined from the information and the latitude in the calculation of the altitude (barometric-altitude measurement) without network connection, user input, or air temperature measurement. The electronic apparatus can therefore suppress a decrease in accuracy in the barometric-altitude measurement even in a situation in which network connection, user input, or air temperature measurement is not allowed.

### APPLICATION EXAMPLE 2

In the electronic apparatus according to the application example, the information may contain at least one of an air temperature table that stores air temperatures on a latitude basis and coefficients of a polynomial that represents the relationship between the latitude and the air temperature.

When the memory memorizes the information in the form of the air temperature table, the processor can obtain an air temperature that should be reflected in the barometric-altitude measurement by referring to the air temperature table in accordance with the latitude. Further, when the memory memorizes the information in the form of the coefficients, the processor can obtain an air temperature that should be reflected in the barometric-altitude measurement by applying the latitude to a polynomial identified by the coefficients.

### APPLICATION EXAMPLE 3

In the electronic apparatus according to the application example, the information may contain an air temperature table that stores air temperatures on a latitude basis in a predetermined zone and coefficients of a polynomial that represents the relationship between the latitude and the air temperature in a zone containing at least a zone different from the predetermined zone, and when a position calculated based on the positioning signal falls within the predetermined zone, the processor uses the air temperature table to calculate the altitude, whereas when the position does not fall within the predetermined zone, the processor uses the coefficients to calculate the altitude.

The processor uses the air temperature table when the position where the electronic apparatus is present falls within the predetermine zone, whereas using the polynomial coefficients when the position does not fall within the predetermined zone. The electronic apparatus can therefore perform the barometric-altitude measurement even when the position where the electronic apparatus is present is located in a zone different from the predetermined zone.

### APPLICATION EXAMPLE 4

In the electronic apparatus according to the application example, the memory may memorize the information on a period basis, and the processor may use the information in a period within which current time falls out of the information on a period basis to calculate the altitude.

The memory memorizes the information on a period basis, and the processor uses the information in a period within which current time falls out of the information on a period basis. The electronic apparatus can therefore suppress a decrease in accuracy in the barometric-altitude measurement even when the air temperature varies over different periods (for example, varies over four seasons and different months).

### APPLICATION EXAMPLE 5

In the electronic apparatus according to the application example, the information may contain daytime information representing a relationship between the latitude and daytime air temperature and nighttime information representing a relationship between the latitude and nighttime air temperature, and when current time falls within the daytime, the processor may use the daytime information to calculate the altitude, whereas when the current time does not fall within the daytime, the processor may use the nighttime information to calculate the altitude.

The processor uses the information for the daytime when the current time falls within the daytime, whereas using the information for the nighttime when the current time falls within the nighttime. The electronic apparatus can therefore perform the barometric-altitude measurement in consideration of the difference between the daytime air temperature and the nighttime air temperature.

### APPLICATION EXAMPLE 6

In the electronic apparatus according to the application example, the processor may correct, in accordance with whether or not current time falls within daytime, the information or an air temperature calculated by using the information.

The processor corrects, in accordance with whether or not the current time falls within the daytime, the information or an air temperature calculated by using the information. The electronic apparatus can therefore perform the barometric-altitude measurement in consideration of the difference between the daytime air temperature and the nighttime air temperature even when the memory separately memorizes the information for the daytime and the information for the nighttime.

### APPLICATION EXAMPLE 7

In the electronic apparatus according to the application example, the polynomial may be a second-order polynomial.

The number of coefficients of a second-order polynomial is typically “3”. The memory therefore only needs to memorize three coefficients as the information.

### APPLICATION EXAMPLE 8

In the electronic apparatus according to the application example, the processor may evaluate whether or not the current time falls within the daytime by using sunrise time and sunset time.

Since the processor uses the sunrise time and the sunset time, the processor can more accurately evaluate whether or not the current time falls within the daytime than in a case where the same time frame is always assumed to be the daytime. The electronic apparatus can therefore perform the barometric-altitude measurement with a decrease in accuracy therein more suppressed in consideration of an effect of the solar movement on the air temperature.

### APPLICATION EXAMPLE 9

In the electronic apparatus according to the application example, the processor may include a converter that converts the barometric pressure into the altitude and a calibrator that calibrates the converter by using the information and the latitude calculated based on the positioning signal.

The calibrator uses the information and the latitude calculated on the basis of the positioning signal to calibrate the converter, which converts the barometric pressure into the altitude. The electronic apparatus can therefore suppress a decrease in accuracy in the barometric-altitude measurement by increasing the accuracy in the calibration on the basis of the information.

### APPLICATION EXAMPLE 10

The electronic apparatus according to the application example may be a mobile electronic apparatus.

The electronic apparatus according to the application example is a mobile electronic apparatus. Therefore, even when a temperature sensor is incorporated in the electronic apparatus, it is difficult to accurately measure the air temperature at the point where the electronic apparatus is present because the temperature sensor is likely to be affected by the user's body temperature. However, since the processor uses the information memorized in the memory in advance instead of a temperature sensor, the air temperature can be calculated without being affected by the body temperature. The electronic apparatus, even though it is a mobile electronic apparatus, can therefore perform the barometric-altitude measurement without being affected by the user's body temperature.

### APPLICATION EXAMPLE 11

An altitude calculation method according to this application example includes detecting barometric pressure, receiving a positioning signal from a positioning satellite, and calculating altitude by using the barometric pressure, latitude calculated based on the positioning signal, and information memorized in advance and representing a relationship between latitude and air temperature.

Since the information representing the relationship between the latitude and the air temperature is memorized in advance, the air temperature determined from the information and the latitude can be reflected in the calculation of the altitude (barometric-altitude measurement) without network connection, user input, or air temperature measurement. The altitude calculation method can therefore suppress a decrease in accuracy in the barometric-altitude measurement even in a situation in which network connection, user input, or air temperature measurement is not allowed.

### APPLICATION EXAMPLE 12

An altitude calculation program according to this application example causes a computer to calculate altitude by using barometric pressure detected with a barometric sensor, latitude calculated based on a positioning signal received from a positioning satellite, and information memorized in advance and representing a relationship between latitude and air temperature.

Since the information representing the relationship between the latitude and the air temperature is memorized in advance, the air temperature determined from the information and the latitude can be reflected in the calculation of the altitude (barometric-altitude measurement) without network connection, user input, or air temperature measurement. The altitude calculation program can therefore suppress a decrease in accuracy in the barometric-altitude measurement even in a situation in which network connection, user input, or air temperature measurement is not allowed.

### BRIEF DESCRIPTION OF THE DRAWINGS

The invention will be described with reference to the accompanying drawings, wherein like numbers reference like elements.

FIG. 1 describes the configuration of an overview of a system including an electronic apparatus.

FIG. 2 is a functional block diagram for describing an example of the configuration of the system including the electronic apparatus.

FIG. 3 describes an example of an air temperature table for daytime associated with a local area.

FIG. 4 describes an example of an air temperature table for nighttime associated with a local area.

FIG. 5 describes an example of a polynomial coefficient table.

FIG. 6 shows an example of data illustrating the relationship between the latitude and the air temperature at a certain point (fitted polynomial).

FIG. 7 is a functional block diagram for describing the function of a signal processor.

FIG. 8 is a flowchart for describing preparation-related-processes carried out by an information terminal.

FIG. 9 is a flowchart for describing preparation-related-processes carried out by a server.

FIG. 10 is a flowchart for describing logging-related-processes carried out by the electronic apparatus.

FIG. 11 is a flowchart for describing barometric-altitude-measurement-related-processes carried out by the electronic apparatus.

FIG. 12 shows experimental data for comparison between an error in barometric-altitude measurement in an embodiment and an error in barometric-altitude measurement in related art.

### DESCRIPTION OF EXEMPLARY EMBODIMENTS

A preferable embodiment of the invention will be described below in detail with reference to the drawings. The embodiment described below is not intended to unduly limit the contents of the invention set forth in the appended claims. Further, all configurations described below are not necessarily essential configuration requirements of the invention.

### 1. Embodiment of Electronic Apparatus

### 1-1. Overview of Electronic Apparatus

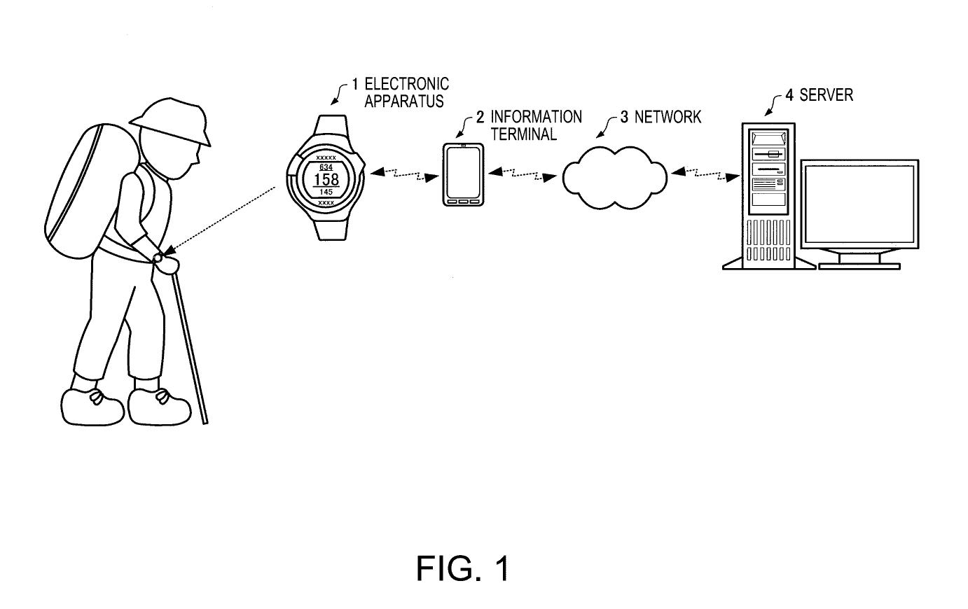

FIG. 1 describes an overview of a system including an electronic apparatus.

The system includes an electronic apparatus 1, an information terminal 2, and a server 4, as shown in FIG. 1.

The electronic apparatus 1 (example of electronic apparatus) is, for example, a mobile information apparatus attached to part of a user's body in an outdoor activity, such as mountain climbing. The body part to which the electronic apparatus 1 is attached is, for example, a site in any position from the elbow to the hand (forearm) so that the electronic apparatus 1 is visible to the user whenever necessary. In the example shown in FIG. 1, the electronic apparatus 1 is configured as a wrist-worn-type (wristwatch-type) mobile information apparatus (outdoor watch), and the body part to which the electronic apparatus 1 is attached is the wrist.

The electronic apparatus 1 has, for example, a clock function, a positioning function, a compass function, a barometric detection function, and a navigation function, which are functions as an outdoor watch. The following description will be made on the assumption that the electronic apparatus 1 is used in mountain climbing.

In preparation for the mountain climbing, the user operates the information terminal 2, such as a smartphone, a tablet PC, and a desktop PC, at a home, a lodging place, or any other place to specify a planned mountain climbing route in the information terminal 2. The information terminal 2 downloads data (such as map data) on an area containing the mountain climbing route (part of local area, for example) from the server 4 via a network 3. When the user connects the information terminal 2 to the electronic apparatus 1, the information terminal 2 writes the downloaded data to the electronic apparatus 1.

During the mountain climbing, a map (simplified map) based on the map data is displayed on a display screen of the electronic apparatus 1, and the latitude, longitude, altitude, direction, and other factors at the point where the user is present are further successively displayed on the display screen (navigation function). In this process, the electronic apparatus 1 displays a latitude (GPS latitude) and a longitude (GPS longitude) calculated on the basis of GPS signals that will be described later as the latitude and longitude at the point where the user is present and further displays an altitude (barometric-sensor altitude) calculated by using the barometric-altitude measurement as the altitude of the point where the user is present. The reason why the barometric-sensor altitude is used as the altitude of the point in place of the GPS altitude is that the GPS altitude contains a positioning error and the barometric-sensor altitude is believed to show more accurate altitude than the GPS altitude. It is, however, noted that the accuracy of the barometric-sensor altitude possibly decreases due, for example, to weather fluctuations. T₀ prevent a decrease in the accuracy of the barometric-sensor altitude, the electronic apparatus 1 calibrates the barometric-altitude measurement every predetermined period or at appropriate timing. The barometric-altitude measurement including the calibration will be described later in detail. Further, the navigation function of the electronic apparatus 1 is achieved by any known method and will not therefore be described in detail.

During the mountain climbing, the electronic apparatus 1 records (logs) the user's a mountain climbing history (mountain climbing log). The mountain climbing log at each point of time contains the latitude, longitude, altitude, and other factors at the point where the user is present. It is assumed in the description that the latitude and longitude in the mountain climbing log are a latitude (GPS latitude) and a longitude (GPS longitude) calculated on the basis of GPS signals, and that the altitude in the mountain climbing log is a barometric-sensor altitude calculated by using the barometric-altitude measurement. The reason why the barometric-sensor altitude is used in place of the GPS altitude as the altitude in the mountain climbing log is that the barometric-sensor altitude is believed to show more accurate altitude than the GPS altitude.

After the mountain climbing, the user connects the information terminal 2 to the electronic apparatus 1 at a home, a lodging place, or any other place. The information terminal 2 reads data on the mountain climbing log (log data) accumulated in the electronic apparatus 1 and uploads the data to the server 4 via the network 3. The server 4 retains the uploaded log data with the log data related to user identification information (user ID). The server 4 then transmits part or entirety of the user's log data to the information terminal 2 via the network 3 in response to the user's request via the information terminal 2. The user can therefore check the user's own mountain climbing log at arbitrary timing on the display screen of the information terminal 2.

### 1-2. Configuration of System

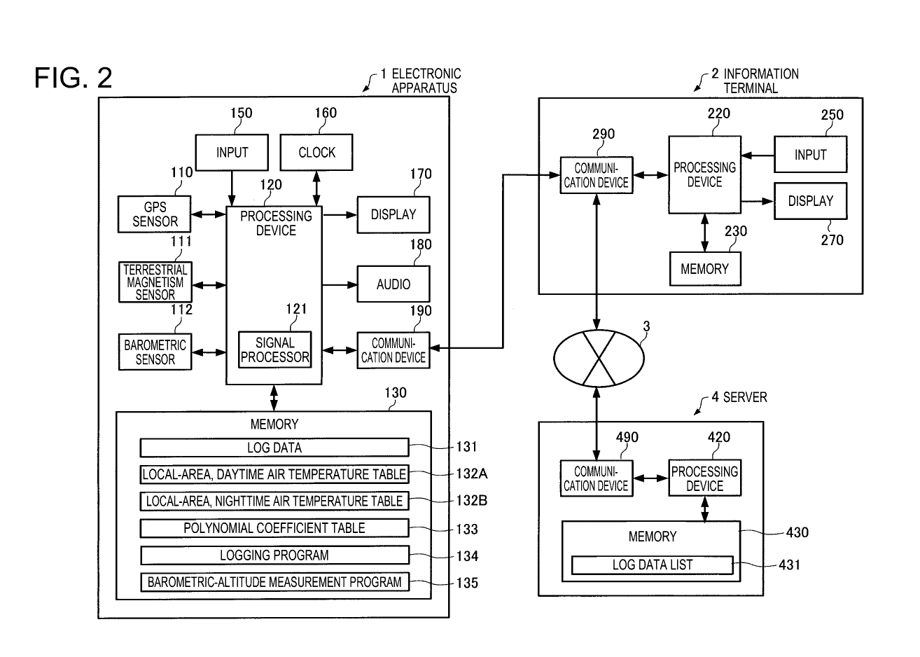

FIG. 2 is a functional block diagram for describing the configuration of the system including the electronic apparatus.

The electronic apparatus 1 includes a GPS sensor (example of receiver) 110, a terrestrial magnetism sensor 111, a barometric sensor 112, a processing device (example of processor, example of computer) 120, a memory 130, an input 150, a clock 160, a display 170, an audio 180, a communication device 190, and other components, as shown in FIG. 2. In the configuration of the electronic apparatus 1, however, part of the constituent elements described above may be omitted or changed, or another constituent element may be added. For example, when no direction needs to be displayed, the electronic apparatus 1 does not need to include the terrestrial magnetism sensor 111. Further, for example, when the user's body temperature needs to be displayed, or when the sensors and other components in the electronic apparatus 1 need to be corrected in accordance with the temperature of the electronic apparatus 1, the electronic apparatus 1 may include a temperature sensor.

The GPS sensor 110 is a sensor that produces positioning data (latitude, longitude, and altitude) representing the position and other factors of the electronic apparatus 1 and outputs the positioning data to the processing device 120, and the GPS sensor 110 includes, for example, a GPS (global positioning system) receiver and other components. The GPS sensor 110 receives an externally incoming electromagnetic wave that belongs to a predetermined frequency band via a GPS antenna that is not shown, extracts a GPS signal (example of positioning signal) transmitted from each GPS satellite (example of positioning satellite), and produces the positioning data representing the position (latitude, longitude, and altitude) and other factors of the electronic apparatus 1 on the basis of the GPS signal.

The terrestrial magnetism sensor 111 is a sensor that detects a terrestrial magnetism vector representing the terrestrial magnetic field direction viewed from the electronic apparatus 1 and produces, for example, terrestrial magnetism data representing magnetic flux densities in three axial directions perpendicular to each other. The terrestrial magnetism sensor 111 is formed, for example, of an MR (magnet resistive) element, an MI (magnet impedance) element, or a Hall element.

The barometric sensor 112 is an element that outputs a signal according to the barometric pressure around the barometric sensor 112 (that is, detects barometric pressure) and has, for example, a pressure sensitive element operating on the basis of a method using a change in the resonance frequency of a vibrating piece (vibration method). The pressure sensitive element is a piezoelectric vibrator made, for example, of quartz, lithium niobate, lithium tantalate, or any other piezoelectric material and is, for example, a tuning-fork-type vibrator, a dual-tuning-fork-type vibrator, an AT vibrator (thickness shear vibrator), or an SAW resonator.

The processing device (example of processor) 120 is formed, for example, of an MPU (micro processing unit), a DSP (digital signal processor), an ASIC (application specific integrated circuit), and other components. The processing device 120 carries out a variety of processes in accordance with a program stored in the memory 130 and a variety of commands inputted by the user via the input 150. The processes carried out by the processing device 120 include data processing in which data produced by the GPS sensor 110, the terrestrial magnetism sensor 111, the barometric sensor 112, the clock 160, and other components are processed (including A/D conversion when input signal is analog signal). The processes carried out by the processing device 120 further include display processing in which the display 170 is caused to display an image, audio processing in which the audio 180 is caused to output audio, and other types of processing. A signal processor 121 shown in FIG. 2 is visualized representation of the functions of the processing device 120, particularly, a function associated with the barometric-altitude measurement. The signal processor 121 will be described later in detail.

The memory 130 is formed, for example, of one or more IC memories and has a ROM that memorizes programs and other types of information and a RAM that serves as a work area used by the processing device 120. The RAM includes a nonvolatile RAM, and the nonvolatile RAM memorizes log data 131, an air temperature table 132A for daytime associated with a local area (example of information, table, or daytime information), an air temperature table 132B for nighttime associated with a local area (example of information, table, or nighttime information), a polynomial coefficient table 133 (example of information or coefficient), and other type of information. The location where at least one of the air temperature tables 132A and 132B and the coefficient table 133 is stored may instead be the ROM. The programs written to the ROM include a barometric-altitude measurement program (example of altitude calculation program) 134 executed by the signal processor 121.

The input 150 is formed, for example, of buttons, keys, a microphone, a touch panel, an audio recognition function, and an action detection function using an accelerator, converts an instruction from the user into an appropriate signal, and transmits the signal to the processing device 120.

The clock 160 is formed, for example, of a real-time clock (RTC) IC, produces time data, such as the year, month, date, hour, minute, and second, and transmits the time data to the processing device 120.

The display 170 is formed, for example, of an LCD (liquid crystal display), an organic EL (electroluminescence) display, an EPD (electrophoretic display), or a touch-panel-type display and displays a variety of images in accordance with an instruction from the processing device 120.

The audio 180 is formed, for example, of a loudspeaker, a buzzer, or a vibrator and produces a variety of type of audio (or vibration) in accordance with an instruction from the processing section 120.

The communication device 190 performs a variety of types of control for establishing data communication between the electronic apparatus 1 and the information terminal 2 (such as smartphone). The communication device 190 includes a transceiver that complies, for example, with Bluetooth (registered trademark) (including BTLE: Bluetooth Low Energy), Wi-Fi (registered trademark) (Wi-Fi: wireless fidelity), Zigbee (registered trademark), NFC (near field communication), ANT+ (registered trademark), or any other short-distance wireless communication standard.

The information terminal 2 is a smartphone, a tablet PC, a desktop PC, or any other information terminal connectable to the network 3, such as the Internet. The information terminal 2 includes a communication device 290, a processing device 220, a memory 230, an input 250, a display 270, and other components.

The communication device 290 is a communication device that can communicate with the communication device 190 of the electronic apparatus 1 and performs a variety of types of control for establishing data communication between the electronic apparatus 1 and the information terminal 2. The communication device 290 includes a transceiver that complies, for example, with Bluetooth (registered trademark) (including BTLE: Bluetooth Low Energy), Wi-Fi (registered trademark) (Wi-Fi: wireless fidelity), Zigbee (registered trademark), NFC (near field communication), ANT+ (registered trademark), or any other short-distance wireless communication standard. The communication device 290 can also communicate with the server 4 via the network 3 and performs a variety of types of control for establishing data communication between the information terminal 2 and the server 4.

The processing device 220 is formed, for example, of an MPU (micro processing unit), a DSP (digital signal processor), an ASIC (application specific integrated circuit), and other components. The processing device 220 carries out a variety of processes in accordance with a program stored in the memory 230 and a variety of commands inputted by the user via the input 250.

The memory 230 is formed, for example, of one or more IC memories and has a ROM that memorizes programs and other types of information and a RAM that serves as a work area used by the processing device 220. The programs are, for example, downloaded from the server 4 via the network 3, such as the Internet.

The input 250 is formed, for example, of buttons, keys, a microphone, a touch panel, an audio recognition function, and an action detection function using an accelerator, converts an instruction from the user into an appropriate signal, and transmits the signal to the processing device 220.

The display 270 is formed, for example, of an LCD (liquid crystal display), an organic EL (electroluminescence) display, an EPD (electrophoretic display), or a touch-panel-type display and displays a variety of images in accordance with an instruction from the processing device 220.

The server 4 is a network server connected to the network 3, such as the Internet. The server 4 includes a communication device 490, a processing device 420, a memory 430, and other components.

The communication device 490 can communicate with the information terminal 2 via the network 3 and performs a variety of types of control for establishing data communication between the information terminal 2 and the server 4.

The processing device 420 is formed, for example, of an MPU (micro processing unit), a DSP (digital signal processor), an ASIC (application specific integrated circuit), and other components. The processing device 420 has a function of managing the log data uploaded by the user of the electronic apparatus 1 via the information terminal 2 and the network 3 with the log data related to the user identification information (user ID), a function of providing the information terminal 2 used by the user of the electronic apparatus 1 with necessary map data and a necessary program.

The memory 430 retains map data on a global area (overall area on the earth). The memory 430 further retains a plurality of users' log data on a user basis (on a user ID basis). In FIG. 2, the log data related to the user ID of the user of the electronic apparatus 1 according to the present embodiment is visualized as a log data list 431. The log data list 431 stores a plurality of sets of log data associated with the user. Each of the plurality of sets of log data is acquired by the logging operation described above.

Each of the electronic apparatus 1, the information terminal 2, and the server 4 transmits and receives the map data and the log data to and from the others in a predetermined format. For example, the processing device 120 of the electronic apparatus 1 transmits, in a predetermined format, the log data 131 stored in the memory 130 to the information terminal 2, and the processing device 220 of the information terminal 2 transmits, in a predetermined format, the log data received from the electronic apparatus 1 to the server 4. The processing device 420 of the server 4 transmits, in a predetermined format, one or more sets of log data contained in the log data list 431 stored in the memory 430 to the information terminal 2. Further, for example, the processing device 420 of the server 4 transmits, in a predetermined format, the map data stored in the memory 430 to the information terminal 2, and the processing device 220 of the information terminal 2 transmits, in a predetermined format, the map data to the electronic apparatus 1. The predetermined formats of data transmitted and received among the electronic apparatus 1, the information terminal 2, and the server 4 may be the same or may differ from one another as required.

### 1-2-1. GPS Sensor

The GPS sensor 110 (example of receiver) includes an RF reception circuit that down-converts a radio-frequency signal (RF signal) received via the antenna that is not shown into an intermediate-frequency signal, amplifies and otherwise processes the intermediate-frequency signal, and then converts the amplified signal into a digital signal.

The GPS sensor 110 further includes a baseband circuit that performs correlation operation and other types of operation on the digital signal (baseband signal) from the RF reception circuit. In place of the down-conversion into an intermediate frequency, a direct conversion method for directly converting the RF signal into the baseband signal can be employed.

The baseband circuit performs known correlation operation on received signals to search for (frequency search, phase search) GPS signals coded on the basis of a predetermined rule so as to capture a plurality of GPS satellites. For each of the captured GPS satellites, the baseband circuit locates a phase and a frequency at which a correlation peak value has been detected and sets the phase and the frequency as a code phase and a reception frequency of the GPS signal.

The baseband circuit further decodes each of the captured GPS signals to acquire an ephemeris (satellite orbit information representing the orbit of the GPS satellite), time information, and other types of information. The baseband circuit uses the acquired ephemeris, time information, and other types of information to perform known operation so as to calculate a pseudo distance between the GPS satellite and the electronic apparatus 1 (a pseudo distance between the GPS satellite and the antenna of the GPS sensor 110 in an exact sense), the velocity vector (the velocity vector of the GPS sensor 110 in an exact sense) of the electronic apparatus 1, the position of the electronic apparatus 1 (the position of the GPS sensor 110 in an exact sense, and the position includes the latitude, the longitude, and the altitude), and other factors of the electronic apparatus 1. The code phase, the pseudo distance, and the velocity vector are other examples of the positioning data.

### 1-2-2. Daytime Air Temperature Table

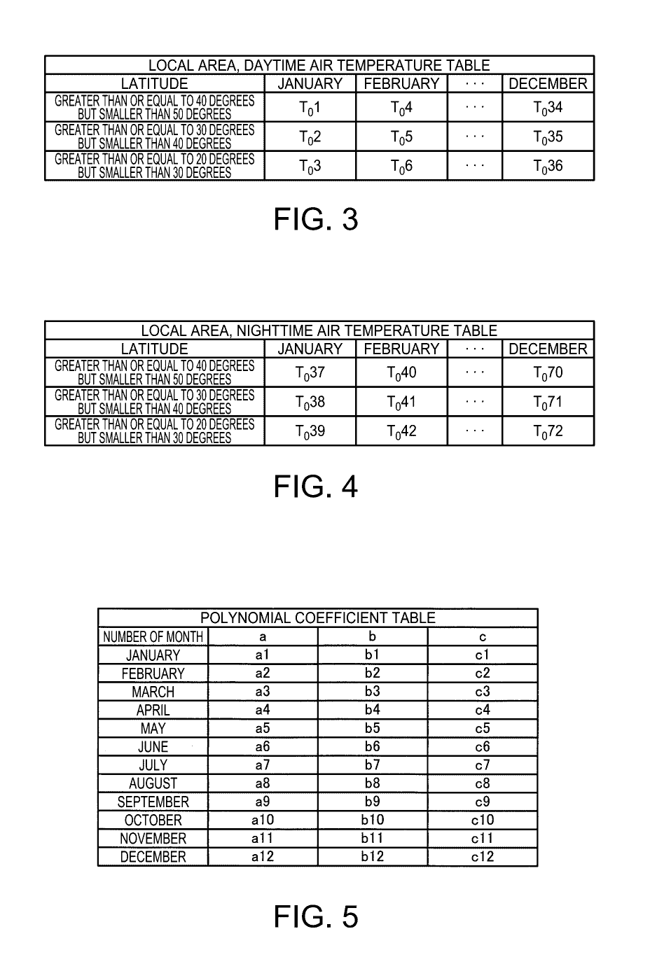

FIG. 3 describes the daytime air temperature table 132A.

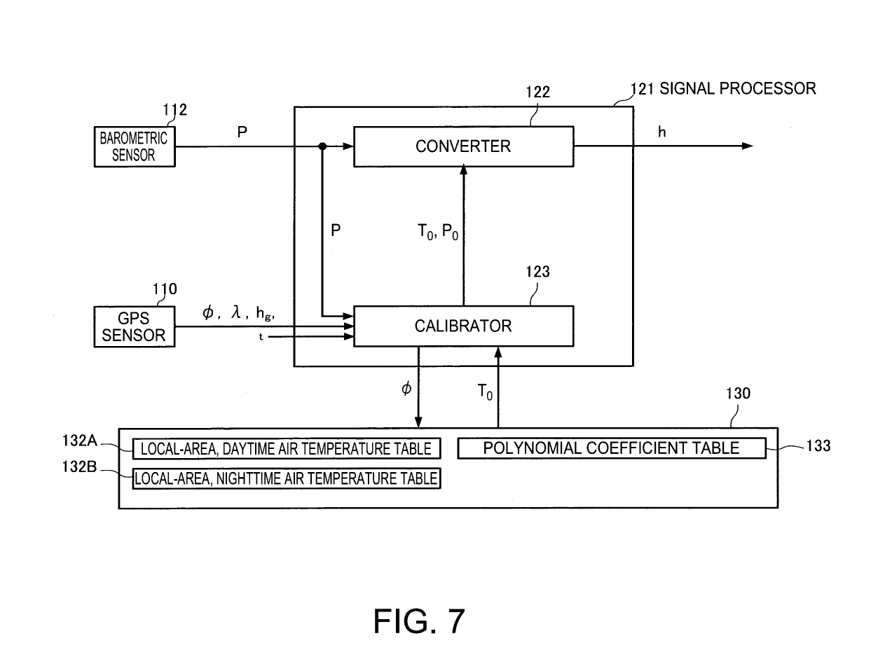

The air temperature table 132A is a table to which a calibrator 123 (see FIG. 7) of the signal processor 121 refers when the barometric-altitude measurement performed by the signal processor 121 is calibrated (when converter 122 in FIG. 7 is calibrated). An input to the air temperature table 132A is the latitude, and an output from the air temperature table 132A is a daytime air temperature (sea-level air temperature). That is, the air temperature table 132A is used to estimate, on the basis of the latitude of the point where the electronic apparatus 1 is present, the daytime air temperature at the same point.

T₀ this end, the air temperature table 132A stores in advance the daytime air temperature in a local area (example of predetermined zone) not only on a latitude basis but also on a period basis (as information statistically processed over predetermined unit period), as shown in FIG. 3. The phrase “stores (memorizes) in advance” used herein means that the air temperature table 132A has stored the daytime air temperatures before the date and time when the barometric-altitude measurement is initiated. For example, the air temperature table 132A preferably stores the daytime air temperatures when the electronic apparatus 1 is shipped from a factory or when the mountain climbing preparation is made.

Each of the daytime air temperatures is statistical data and is, for example, a daytime average sea-level air temperature averaged over a plurality of past years in each period. The sea-level air temperature refers to the air temperature at a point where the altitude is zero meters (zero-meter point above sea level).

The local area is a primary area where the user plans to use the electronic apparatus 1 and is, for example, an area where the electronic apparatus 1 was shipped. For example, in a case where the area where the electronic apparatus 1 was shipped is “Japan,” the air temperature table 132A is, for example, a table that stores daytime sea-level air temperatures on the ground and on the sea in Japan on a latitude basis.

The term “daytime” used herein is a period from the sunrise time to the sunset time. The period from the sunset time to the sunrise time is the “nighttime.” The sunrise time and the sunset time on the current date can be calculated, for example, on the basis of the number of the current month and the current date. The method for calculating the sunrise time and the sunset time will be described later.

The increment of the latitude in the air temperature table 132A is set, for example, at 10 degrees, as shown in FIG. 3. The increment (interval) of the latitude may be greater than or smaller than 10 degrees, and the greater the increment, the smaller the amount of data in the air temperature table 132A, whereas the smaller the increment, the higher the accuracy of the table (accuracy in air temperature estimation).

The increment of the period in the air temperature table 132A is set, for example, at one month, as shown in FIG. 3. The increment of the period may be greater than one month (three months, for example) or smaller than one month (predetermined days, for example), and the greater the increment, the smaller the amount of data in the air temperature table 132A, whereas the smaller the increment, the higher the accuracy of the table (accuracy in air temperature estimation).

The range of the period in the air temperature table 132A is set to be equal to the cycle of change in the air temperature in the local area (one year, for example).

In a case where the local area is an area having the four seasons (area remote from the equator), the increment of the period in the air temperature table 132A may be set to be equal to the increment of the four seasons (about three months), whereas in a case where the local area is an area not having the four seasons (area close to the equator or polar area), the increment of the period in the air temperature table 132A may be set at zero. Further, the increment of the period may be uniform or non-uniform (for example, one table may have a segment where the increment of the period is one month, a segment where the increment of the period is two months, and a segment where the increment of the period is three months).

### 1-2-3. Nighttime Air Temperature Table

FIG. 4 describes the nighttime air temperature table 132B.

The air temperature table 132B is a table to which the calibrator (reference character 123 in FIG. 7) of the signal processor 121 refers when the barometric-altitude measurement performed by the signal processor 121 is calibrated (when converter 122 in FIG. 7 is calibrated). An input to the air temperature table 132B is the latitude, and an output from the air temperature table 132B is a nighttime air temperature (sea-level air temperature). That is, the air temperature table 132B is used to estimate, on the basis of the latitude of the point where the electronic apparatus 1 is present, the nighttime air temperature at the same point.

T₀ this end, the air temperature table 132B stores in advance the nighttime air temperature in the local area (example of predetermined zone) not only on a latitude basis but also on a period basis, as shown in FIG. 4.

Each of the nighttime air temperatures is statistical data and is, for example, a nighttime average sea-level air temperature averaged over a plurality of past years in each period. The sea-level air temperature refers to the air temperature at the point where the altitude is zero meters (zero-meter point above sea level).

The local area is a primary area where the user plans to use the electronic apparatus 1 and is, for example, an area where the electronic apparatus 1 was shipped. For example, in a case where the area where the electronic apparatus 1 was shipped is “Japan,” the air temperature table 132B is, for example, a table that stores nighttime sea-level air temperatures on the ground and on the sea in Japan on a latitude basis.

The term “nighttime” used herein is a period from the sunset time to the sunrise time (the period from the sunrise time to the sunset time is the “daytime”). The sunrise time and the sunset time on the current date can be calculated, for example, on the basis of the number of the current month and the current date. The method for calculating the sunrise time and the sunset time will be described later.

The increment of the latitude in the air temperature table 132B is set, for example, at 10 degrees, which is equal to the increment of the latitude in the air temperature table 132A, that is, as shown in FIG. 4. The increment (interval) of the latitude may be greater than or smaller than 10 degrees (predetermined days, for example), and the greater the increment, the smaller the amount of data in the air temperature table 132B, whereas the smaller the increment, the higher the accuracy of the table (accuracy in air temperature estimation).

The increment of the period in the air temperature table 132B is set, for example, at one month, which is equal to the increment of the period in the air temperature table 132A, that is, as shown in FIG. 4. The increment of the period may be greater than one month (three months, for example) or smaller than one month, and the greater the increment, the smaller the amount of data in the air temperature table 132B, whereas the smaller the increment, the higher the accuracy of the table (accuracy in air temperature estimation).

The range of the period in the air temperature table 132B is set to be equal to the range of the period in the air temperature table 132A, that is, the cycle of change in the air temperature in the local area (one year, for example).

In a case where the local area is an area having the four seasons (area remote from the equator), the increment of the period in the air temperature table 132B may be set to be equal to the increment of the four seasons (three months), whereas in a case where the local area is an area not having the four seasons (area close to the equator or polar area), the increment of the period in the air temperature table 132B may be set at zero. Further, the increment of the period may be uniform or non-uniform (For example, one table may have a segment where the increment of the period is one month, a segment where the increment of the period is two months, and a segment where the increment of the period is three months).

### 1-2-4. Polynomial Coefficient Table

FIG. 5 describes the polynomial coefficient table 133.

The polynomial coefficient table 133 is a table to which the calibrator (reference character 123 in FIG. 7) of the signal processor 121 refers when the barometric-altitude measurement performed by the signal processor 121 is calibrated (when converter 122 in FIG. 7 is calibrated). An input to the coefficient table 133 is the latitude, and an output from the coefficient table 133 is an air temperature (air temperature common to daytime and nighttime). That is, the coefficient table 133 is used to estimate, on the basis of the latitude of the point where the electronic apparatus 1 is present, the nighttime or daytime air temperature at the same point.

The coefficient table 133 stores coefficients of a polynomial that expresses the air temperature (sea-level air temperature) in the global area (example of zone containing zone different from predetermined zone) in the form of a function of the latitude, as shown in FIG. 5. The polynomial is an equation for estimating an air temperature (sea-level air temperature) from the latitude.

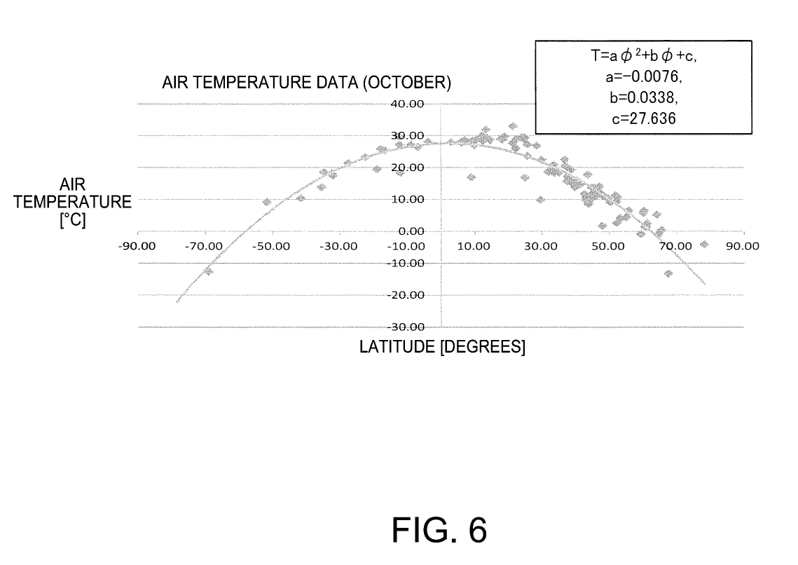

For example, using the meteorological data open to the public on the Homepage (Website) of Japan Meteorological Agency, the polynomial is obtained by fitting statistical data on the air temperature in the global area, as shown in FIG. 6. The horizontal axis of FIG. 6 represents the latitude [degrees], and the vertical axis of FIG. 6 represents the air temperature [° C.]. The statistical data (each dot) in FIG. 6 represents the average air temperature in October at points where the longitude is the same but the latitude differs from one another.

The polynomial is, for example, a second-order polynomial, as shown right above in FIG. 6. The second-order polynomial is expressed by T₀=4φ²+bφ+c, where T₀ represents the sea-level air temperature [° C.] and φ represents the latitude. That is, the polynomial is identified by the second-order coefficient “a”, the first-order coefficient b, and the zero-order coefficient c.

The global area is an area containing at least an area different from the local area described above and is, for example, the overall area on the earth. Therefore, in the present embodiment, when the point where the electronic apparatus 1 is present falls within the local area, the air temperature table 132A or the air temperature table 132B described above is used to estimate the air temperature, whereas when the point where the electronic apparatus 1 does not fall within the local area, the coefficient table 133 is used to estimate the air temperature. The global area may be a partial zone on the earth or may not contain any partial zone on the earth. The global area may or may not contain the local area, but when the coefficient table 133 is used in a position outside the local area, the global area preferably contains an area outside the local area.

The polynomial is assumed to be a second-order polynomial in the description, but the polynomial may instead be a first-order polynomial, a third-order polynomial, or a polynomial having an order greater than three. The lower the order of the polynomial, the smaller the amount of data in the coefficient table 133, whereas the higher the order of the polynomial, the higher the accuracy of the table (accuracy in air temperature estimation) depending on the tendency of change in the air temperature.

The increment of the period in the polynomial coefficient table 133 is set, for example, at one month, as shown in FIG. 5. The increment of the period may be greater than or smaller than one month, and the greater the increment, the smaller the amount of data in the coefficient table 133, whereas the smaller the increment, the higher the accuracy of the table (accuracy in air temperature estimation).

The range of the period in the coefficient table 133 is set to be equal to the cycle of change in the air temperature in the global area (one year), as shown in FIG. 5.

### 1-2-4. Signal Processor

FIG. 7 is a functional block diagram for describing the function of the signal processor 121.

The signal processor 121 includes a converter 122 and a calibrator 123, as shown in FIG. 7.

The signal processor 121 receives at least barometric pressure P outputted from the barometric sensor 112, latitude φ outputted from the GPS sensor 110, longitude λ outputted from the GPS sensor 110, altitude (GPS altitude) h_{g} outputted from the GPS sensor 110, and time t (example of current time) outputted from the clock 160. The time t used herein is assumed to contain information on the number of the year, the number of the month, the date, and the hour and minute. The time t may not contain the number of the year. Further, the time t may be corrected as appropriate on the basis of the GPS time determined from the GPS signals.

The converter 122 applies the barometric pressure P outputted from the barometric sensor 112 to a predetermined conversion equation (altitude measurement formula) to convert the barometric pressure P into a barometric-sensor height h and outputs the barometric-sensor height h. The conversion and the output operation is repeatedly performed, for example, at predetermined time intervals. The barometric-sensor height h outputted by the converter 122 therefore represents the altitude of the point where the electronic apparatus 1 is present roughly in a real-time manner.

The conversion equation used by the converter 122 is expressed, for example, by the following Expression (1).

$$h = \frac{( 1 - {( \frac{P}{{P}_{0}} )}^{\frac{1}{5.257}} ) \times ( {T}_{0} + 273.15 )}{0.0065} \qquad ( 1 )$$

In the conversion equation (1), the parameter P₀ represents the sea-level barometric pressure, and the parameter T₀ represents the sea-level air temperature. The values of the parameters T₀ and P₀ are set (calibrated) by the calibrator 123 at necessary timing or on a regular basis.

The barometric-sensor height h outputted from the converter 122 is written as the altitude in the log data 131 to the memory 130 by a recorder (not shown) of the processing device 120. Further, the barometric-sensor height h outputted from the converter 122 is converted by a display processor (not shown) of the processing device 120 into image data representing the altitude, and the image data is displayed as an image on the display 170. Instead, the barometric-sensor height h outputted from the converter 122 is, for example, converted by a notification processor (not shown) of the processing device 120 into audio data representing the altitude, and the audio data is outputted as audio from the audio 180.

The calibrator 123 receives as inputs the barometric pressure P, the latitude φ, the longitude λ, the GPS altitude h_{g}, and the time t.

The calibrator 123, which is one of the components that form the signal processor 121, selects one of the air temperature tables 132A, 132B and the coefficient table 133 on the basis of the latitude φ, the longitude λ, the time t, and other factors, calculates the sea-level air temperature T₀ on the basis of the selected table and the latitude φ, and sets the calculated sea-level air temperature T₀ in the converter 122.

The calibrator 123 further applies the barometric pressure P, the GPS altitude h_{g}, and the sea-level air temperature T₀ to the following conversion equation (2) to calculate the sea-level barometric pressure P₀ and sets the calculated sea-level barometric pressure P₀ in the converter 122.

$${P}_{0} = P \times {( \frac{1 - ( 0.0065 \times {h}_{g} )}{{T}_{0} + 273.15} )}^{- 5.257} \qquad ( 2 )$$

The calibrator 123 therefore needs no user input, network connection, or air temperature measurement. The calibrator 123 can therefore calibrate the converter 122 even under a situation in which no user input, network connection, or air temperature measurement is allowed.

Further, the calibrator 123, when it calculates the sea-level air temperature T₀, appropriately uses one of the air temperature tables 132A, 132B and the coefficient table 133 in accordance with the situation to suppress a decrease in accuracy in the calculation of the sea-level air temperature T₀ and hence a decrease in accuracy in the calibration. The calibrator 123 can therefore suppress a decrease in accuracy in the barometric-sensor height h.

### 1-3-1. Calculation of Sunrise Time

A method for calculating the sunrise time will be described below. The following calculation method basically describes the principle of the calculation and partially uses an approximation to reduce the calculation burden. The following calculation method may be further approximated, deformed, or otherwise changed to the extent based on the principle of the calculation.

Input values in the calculation method are as follows.

Current latitude: φ

Current longitude: λ

Current year: y

Number of current month: m

Current date: d

Constants used in the calculation are as follows.

Constants used in calculation of the solar ecliptic diameter λₛ are those in the following table.

TABLE 1

| Constant | Value |
|---|---|
| a₀₀ | 274.7284 |
| a₀₁ | 361.3202 |
| a₀₂ | −0.12002 |
| a₀₃ | 0.005491 |
| a₀₄ | −0.00013 |
| a₀₅ | 1.17E−06 |
| f | 2.094184 |
| a₁₀ | −1.14942 |
| a₁₁ | 0.170251 |
| a₁₂ | −0.00836 |
| a₁₃ | 0.000136 |
| t₁ | −3.23423 |
| a₂₀ | 0.837366 |
| a₂₁ | −0.12391 |
| a₂₂ | 0.006046 |
| a₂₃ | −9.73E−05 |
| t₂ | −5.27486 |
| a₃₀ | 1.829296 |
| a₃₁ | 0.007792 |
| a₃₂ | −0.00013 |
| a₃₃ | −2.30E−06 |
| t₃ | −6.31668 |

Constants used in calculation of the distance r to the sun are those in the following table.

TABLE 2

| Constant | Value |
|---|---|
| a₀ | 1.000132 |
| a₁ | 2.74E−07 |
| f | 1.047107 |
| b₁ | 1.02E−06 |
| b₂ | −15.9417 |
| c₁ | −1.6E−06 |
| c₂ | −4.9418 |
| d₁ | −2.6E−06 |
| d₂ | −14.0125 |

Before the calculation of the sunrise time, an initial value of the sun appearing time (sunrise time) d is determined. The initial value may be zero or a value close to actual sun appearing time. The time d is greater than or equal to 0 but smaller than or equal to 24.

The procedure of the calculation of the sunrise time is formed of the following steps (1) to (11).

(1) A time constant T is calculated by using the following equation.

K=365y+30m+d−33.5+[3×(m+1)/5]+[y/4],

T=((K+(y−1999)+64)×86400)/365.25

In the equation, the symbol [ ] represents the Gauss symbol, and [A] represents the greatest integer that is not greater than the numeral A. When the number of the current month is “1” or “2”, the number of the current month is set to be the thirteenth or fourteenth month of the preceding year. That is, when m=1 or m=2, y and m are set as follows: y=y−1; and m=13 or m=14.

(2) The solar ecliptic diameter λₛ is calculated by using the following equation.

λₛ=a₀₀+a₀₁·T+a₀₂·T²+a₀₃·T³+a04·T⁴+a₀₅·T⁵+(a₁₀+a₁₁·T+a₁₂·T²+a₁₃·T³)sin(f·T+t₁)+(a₂₀+a₂₁·T+a₂₂·T²+a₂₃·T³)sin(2f·T+t₂)+(a₃₀+a₃₁·T+a₃₂·T²+a₃₃·T³)sin(3f·T+t₃)

(3) The distance r to the sun is calculated by using the following equation

r=a₀+a₁·T+b₁·sin(f·T+b₂)+c₁·sin(2f·T+c₂)+d₁·sin(3f·T+d₂)

(4) The obliquity ε of the ecliptic is calculated by using the following equation.

ε=23.439291−0.000130042T

(5) The solar equatorial diameter α is calculated by using the following equation.

α=a tan(tan λXs·cos ε)

(6) The declination of the sun σ is calculated by using the following equation.

σ=a sin(sin λs·sin ε)

(7) The sidereal time Θ is calculated by using the following equation.

Θ=100.4606+360.007700536T+0.00000003879T²+λ+360d

(8) The appearance altitude k is calculated by using the following equation.

Visual radius S=0.266994/r

Atmospheric refraction R=0.585555556

Equatorial horizontal parallax Π=0.002442819/r

Appearance altitude k=−S−R+Π

(9) The appearance point hour angle tₖ is calculated by using the following equation.

tₖ=a cos((sin k−sin σ·sin Φ)/cos σ·cos Φ)

tₖ=−tₖ

(10) The sunrise time is calculated by using the following equation.

Celestial hour angle t=Θ·α

Correction value Δd=(tₖ−t)/360

(11) Set d=d+Δd and repeat steps (7) to (10) until |Δd|<0.00005 is satisfied. The value d at the point of time when |Δd|<0.00005 is satisfied is then set to be the sunrise time.

### 1-3-2. Calculation of Sunset Time

The sunset time can be calculated by carrying out the steps (7) to (11) in the same manner as in the method for calculating the sunrise time. However, the equation “tₖ=−tₖ” in step (9) is not required. The calculation method described above is presented only by way of basic example, and in actual calculation, an equation based on the principle, an approximation, or a deformed equation may be used. Using an approximation allows suppression of the calculation burden.

### 1-4. Processes Carried Out by System

### 1-4-1. Processes Carried Out by Information Terminal

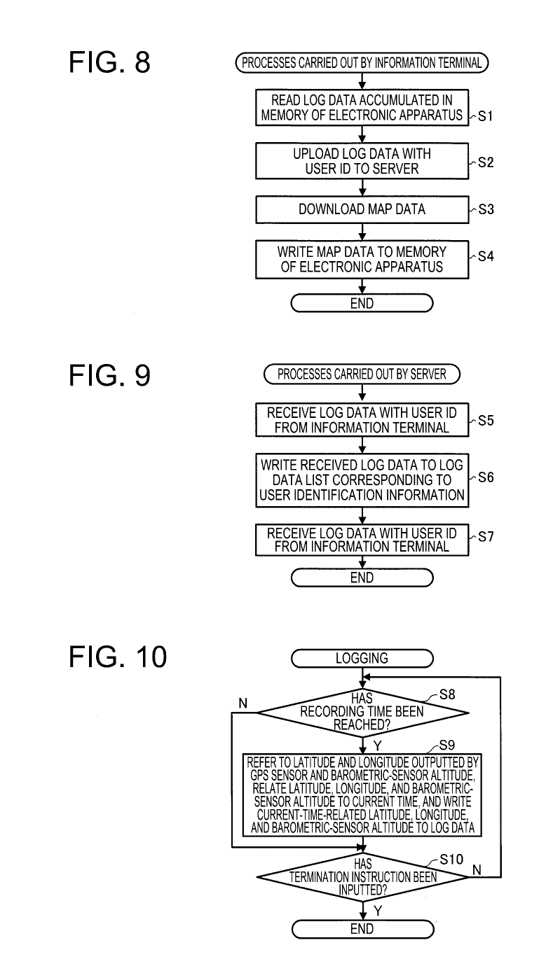

FIG. 8 is a flowchart for describing preparation-related-processes carried out by the information terminal 2. In the preparation, it is assumed that the information terminal 2 is connected to the network 3 and the electronic apparatus 1 so that the electronic apparatus 1 and the server 4 can communicate with each other. Each step in FIG. 8 will be sequentially described below.

Step 1: The processing device 220 of the information terminal 2 communicates with the processing device 120 of the electronic apparatus 1 via the communication device 290 of the information terminal 2 and the communication device 190 of the electronic apparatus 1 to read log data accumulated in the memory 130 of the electronic apparatus 1.

Step S2: The processing device 220 of the information terminal 2 transmits, in a predetermined format, the log data to which the user ID is attached (log data with user ID) to the processing device 420 of the server 4. The transmission is performed via the communication device 290 of the information terminal 2, the network 3, and the communication device 490 of the server 4.

Step S3: The processing device 220 of the information terminal 2 notifies the processing device 420 of the server 4 of a planned mountain climbing route and other types of information. The notification is performed via the communication device 290 of the information terminal 2, the network 3, and the communication device 490 of the server 4. The notified mountain climbing route is, for example, a mountain climbing route specified in advance by the user in the information terminal 2. The processing device 220 of the information terminal 2 then receives map data on an area that covers the notified mountain climbing route from the processing device 420 of the server 4. The reception is performed via the communication device 490 of the server 4, the network 3, and the communication device 290 of the information terminal 2.

Step S4: The processing device 220 of the information terminal 2 writes, in a predetermined format, the received map data in the memory 130 of the electronic apparatus 1. The writing is performed via the communication device 290 of the information terminal 2 and the communication device 190 of the electronic apparatus 1.

### 1-4-2. Processes Carried Out by Server

FIG. 9 is a flowchart for describing preparation-related-processes carried out by the server 4. In the preparation, it is assumed that the server 4 is connected to the network 3 so that the server 4 can communicate with the information terminal 2. Each step in FIG. 9 will be sequentially described below.

Step 5: The processing device 420 of the server 4 receives the log data with the user ID from the processing device 220 of the information terminal 2. The reception is performed via the communication device 490 of the server 4, the network 3, and the communication device 290 of the information terminal 2.

Step S6: The processing device 420 of the server 4 writes the received log data with the user ID to the log data list 431 related to the user ID in the memory 430.

Step S7: The processing device 420 of the server 4, when it receives notification of a mountain climbing route from the processing device 220 of the information terminal 2, reads map data that covers the mountain climbing route from the map data stored in the memory 430 and transmits the read map data to the processing device 220 of the information terminal 2. The transmission is performed via the communication device 490 of the server 4, the network 3, and the communication device 290 of the information terminal 2.

### 1-4-3. Processes (Logging) Carried Out by Electronic Apparatus

FIG. 10 is a flowchart for describing logging-related-processes carried out by the electronic apparatus 1. The processes are carried out, for example, in response to an initiation instruction from the user on the day of the mountain climbing and in accordance with a logging program 134. The initiation instruction is inputted, for example, by the user's operation of the input 150. Each step in FIG. 10 will be sequentially described below.

Step S8: The processing device 120 of the electronic apparatus 1 evaluates whether or not logging recording time has been reached. When a result of the evaluation shows that the logging recording time has been reached (Y in S8), the processing device 120 proceeds to step S9, whereas when a result of the evaluation shows that the logging recording time has not been reached (N in S8), the processing device 120 proceeds to step S10. The logging recording time is repeatedly reached, for example, at predetermined time intervals. The predetermined time intervals are, for example, time intervals specified by the user in advance in the electronic apparatus 1. The specification of the time intervals is performed, for example, by the user's operation of the input 150.

Step S9: The processing device 120 of the electronic apparatus 1 refers to the latitude φ and the longitude λ outputted by the GPS sensor 110, the barometric-sensor altitude h outputted by the signal processor 121, and the time t outputted by the clock 160 and writes the latitude φ, the longitude λ, and the altitude h that are related to the time t as the latest log data to the log data 131 in the memory 130.

Step S10: The processing device 120 of the electronic apparatus 1 evaluates whether or not a termination instruction has been inputted. When a result of the evaluation shows that the termination instruction has been inputted (Y in S10), the processes are terminated, whereas when a result of the evaluation shows that the termination instruction has not been inputted (N in S10), the processing device 120 proceeds to step S8.

### 1-4-4. Processes Carried Out by Electronic Apparatus (Barometric-Altitude Measurement)

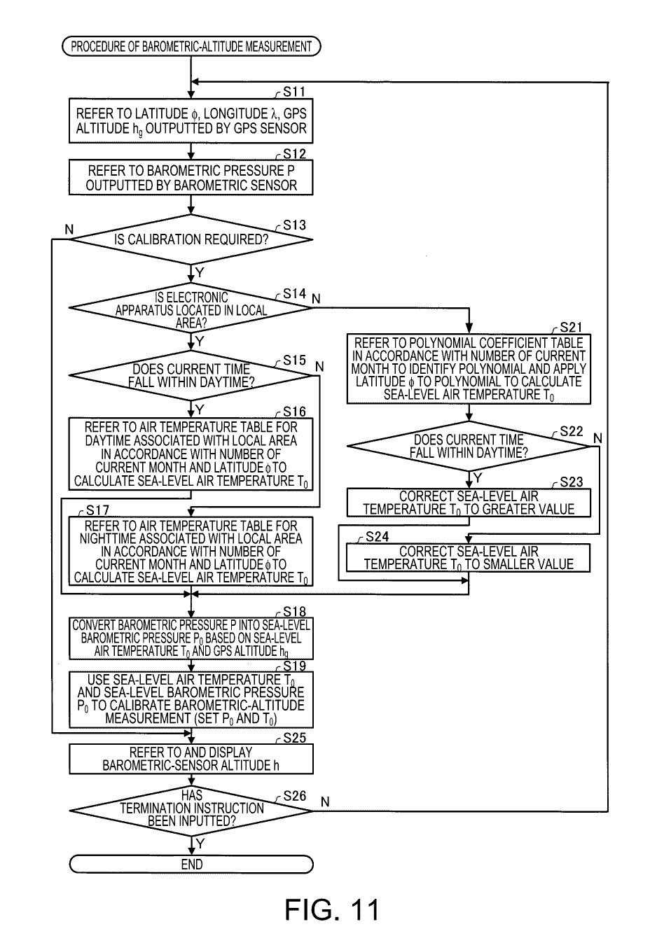

FIG. 11 is a flowchart for describing barometric-altitude-measurement-related-processes carried out by the electronic apparatus 1. The processes are carried out, for example, in response to the initiation instruction from the user on the day of the mountain climbing and in accordance with a barometric-altitude measurement program 135. The processes are an example of an altitude measurement method performed by the processing device 120 when it reads and executes the barometric-altitude measurement program 135. The initiation instruction is inputted, for example, by the user's operation of the input 150. Each step in FIG. 11 will be sequentially described below.

Step S11: The processing device 120 of the electronic apparatus 1 refers to the latitude φ, the longitude λ, and the GPS latitude h_{g} outputted by the GPS sensor 110. The latitude φ, the longitude λ, and the GPS latitude h_{g} represent the position of the point where the electronic apparatus 1 is present.

Step S12: The processing device 120 refers to the barometric pressure P outputted by the barometric sensor 112. The barometric pressure P represents the barometric pressure at the point where the electronic apparatus 1 is present.

Step S13: The processing device 120 evaluates whether or not the barometric-altitude measurement needs to be calibrated. For example, when the difference between the barometric-sensor altitude h and the GPS altitude h_{g} is greater than a predetermined threshold, the processing device 120 determines that the barometric-sensor altitude h has low reliability and therefore needs to be calibrated, whereas when the difference is not greater than the predetermined threshold, the processing device 120 determines that the barometric-sensor altitude h has high reliability and therefore does not need to be calibrated. When the processing device 120 has determined that the calibration is required (Y in S13), the processing device 120 proceeds to step S14, whereas when the processing device 120 has determined that no calibration is required (N in S13), the processing device 120 proceeds to step S25.

Step S14: The calibrator 123 of the processing device 120 evaluates, on the basis of the latitude φ and the longitude λ, whether or not the point where the electronic apparatus 1 is present falls within the local area described above. When the calibrator 123 has determined that the point falls within the local area (Y in S14), the calibrator 123 proceeds to step S15, whereas when the calibrator 123 has determined that the point does not fall within the local area (N in S14), the calibrator 123 proceed to step S21.

In steps from S15 to S19, the calibration using the air temperature tables 132A and 132B associated with the local area is performed, and in steps from S21 to S24, step S18, and step S19, the calibration using the polynomial coefficient table 133 is performed.

The air temperature tables 132A and 132B associated with the local area can be used only in the local area but advantageously allow the calibration to be performed with high accuracy. On the other hand, the polynomial coefficient table 133 causes the accuracy in the calibration to be lower than the air temperature tables 132A and 132B but can be advantageously used not only in the local area but also in the other areas.

Step S15: The calibrator 123 of the processing device 120 refers to the time t outputted by the clock 160. The time t represents information on the number of the current year, the number of the current month, the current date, and the current hour and minute. The calibrator 123 of the processing device 120 evaluates whether or not the current hour and minute fall within the daytime (period from sunrise time to sunset time) on the current date. When a result of the evaluation shows that the current hour and minute fall within the daytime (Y in S15), the calibrator 123 proceeds to step S16, whereas when a result of the evaluation shows that the current hour and minute do not fall within the daytime (N in S15), the calibrator 123 proceeds to step S17. In step S15, the method described above for calculating the sunrise time and the sunset time on the current data is used.

Step S16: The calibrator 123 of the processing device 120 refers to the air temperature table 132A for daytime associated with the local area in accordance with the number of the current month and the latitude φ to calculate (estimate) the sea-level air temperature T₀ at the point where the electronic apparatus 1 is present, and the processing device 120 proceeds to step S18.

Step S17: The calibrator 123 of the processing device 120 refers to the air temperature table 132B for nighttime associated with the local area in accordance with the number of the current month and the latitude φ to calculate (estimate) the sea-level air temperature T₀ at the point where the electronic apparatus 1 is present, and the processing device 120 proceeds to step S18.

Step S18: The calibrator 123 of the processing device 120 converts the barometric pressure P into the sea-level barometric pressure P₀ on the basis of the sea-level air temperature T₀ and the GPS altitude h_{g}. An equation for converting the barometric pressure P into the sea-level barometric pressure P₀ is Expression (2) described above.

Step S19: The calibrator 123 of the processing device 120 calibrates the converter 122 on the basis of the calculated sea-level air temperature T₀ and sea-level barometric pressure P₀. Specifically, the calibrator 123 of the processing device 120 sets the calculated sea-level air temperature T₀ and sea-level barometric pressure P₀ to be the parameters T₀ and P₀ of the conversion equation (1) used by the converter 122.

Step S21: The calibrator 123 of the processing device 120 refers to the polynomial coefficient table 133 in accordance with the number of the current month to calculate the polynomial's coefficients a, b, and c for calculating (estimating) the sea-level air temperature T₀. The calibrator 123 of the processing device 120 then applies the latitude φ to the polynomial identified by the coefficients a, b, and c to calculate (estimate) the sea-level air temperature T₀ at the point where the electronic apparatus 1 is present.

Step S22: The calibrator 123 of the processing device 120 refers to the time t outputted by the clock 160. The time t represents information on the number of the current month, the current date, and the current hour and minute. The calibrator 123 of the processing device 120 then evaluates whether or not the current hour and minute fall within the daytime (period from sunrise time to sunset time) on the current date. When a result of the evaluation shows that the current hour and minute fall within the daytime on the current date (Y in S22), the calibrator 123 proceeds to step S23, whereas when a result of the evaluation shows that the current hour and minute do not fall within the daytime on the current date (N in S22), the calibrator 123 proceeds to step S24. In step S22, the method described above for calculating the sunrise time and the sunset time on the current data is used.

Step S23: The calibrator 123 of the processing device 120 corrects the sea-level air temperature T₀ to a greater value, for example, by using an equation T₀=T₀+2. The reason for this is that the air temperature in the daytime tends to be higher than the average air temperature. The calibrator 123 then proceeds to step S18.

Step S24: The calibrator 123 of the processing device 120 corrects the sea-level air temperature T₀ to a smaller value, for example, by using an equation T₀=T₀−2. The reason for this is that the air temperature in the nighttime tends to be lower than the average air temperature. The calibrator 123 then proceeds to step S18.

Step S25: The processing device 120 refers to the barometric-sensor altitude h and displays the barometric-sensor altitude h in the form of an image, such as a text, on the display 170. The processing device 120 further causes the audio 180 to output the barometric-sensor altitude h as required in the form of audio.

Step S26: The processing device 120 evaluates whether or not the user has inputted the termination instruction. When a result of the evaluation shows that the termination instruction has been inputted (Y in S26), the processing device 120 terminates the processes, whereas when a result of the evaluation shows that the termination instruction has not been inputted (N in S26), the processing device 120 proceeds to step S11. The termination instruction is inputted, for example, by the user's operation of the input 150.

In the processes described above, the order in which the steps described above are carried out can be changed as appropriate. For example, the points of time at which steps S11 and S12 are carried out can be swapped with each other.

### 1-5. Accuracy in Barometric-Altitude Measurement

The accuracy in the barometric-altitude measurement in the present embodiment will be described below.

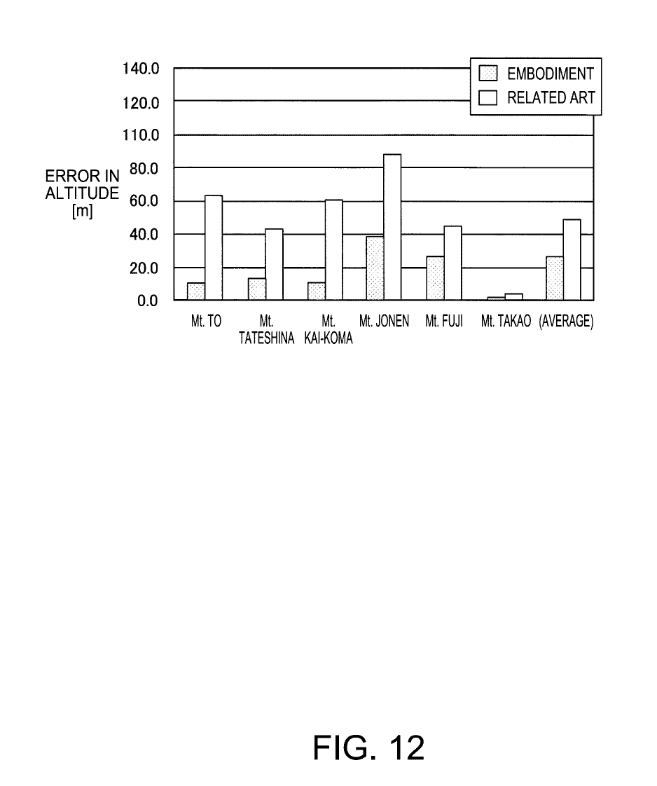

FIG. 12 a graph showing experimental data for comparison between an error in the barometric-altitude measurement in the present embodiment and an error in the barometric-altitude measurement in related art. The horizontal axis of FIG. 12 represents the names of mountains where the experiment was conducted, and the vertical axis of FIG. 12 represents the errors in the two types of barometric-altitude measurement. In the experiment, the error in each of the two types of barometric-altitude measurement is the absolute value [m] of the difference between the barometric-sensor altitude h calculated at the summit of each of the mountains and the true altitude of the summit of the mountain. The experiment conditions are as follows.

(1) Each of the mountains where the experiment was conducted was located in the local area (That is, one of the air temperature tables is used instead of the coefficient table in the calibration).

(2) At an ascending start point of each of the mountains, the calibration using true altitude (altitude written in official map) was performed. More specifically, true altitude was substituted into the GPS altitude h_{g} of the conversion equation (2) and barometric pressure actually measured with the barometric sensor at the ascending start point was substituted into the barometric pressure P of the conversion equation (2) to determine the sea-level barometric pressure P₀.

(3) In the barometric-altitude measurement in the present embodiment (“Embodiment” in FIG. 12), to determine the sea-level barometric pressure P₀ in (2) described above, the processing device 120 refers to one of the air temperature tables to determine the sea-level air temperature at the latitude of the ascending start point and substitutes the determined sea-level air temperature into the sea-level air temperature T₀ of the conversion equation (2). The increment of the latitude in the air temperature table was set at “seven degrees.”

(4) In the “barometric-altitude measurement in related art” (“Related art” in FIG. 12), the calibration was performed by using the temperature detected with a temperature sensor in place of the air temperature calculated by using one of the air temperature tables in the barometric-altitude measurement in the present embodiment. Since the temperature detected with a temperature sensor is a temperature in the position where the electronic apparatus is present, a sea-level air temperature is obtained by using a known conversion equation based on a temperature lapse rate of 0.0065 [° C./m], and the obtained sea-level air temperature was substituted into the sea-level air temperature T₀ of the conversion equation (2).

(5) In the experiment, a wrist-worn-type electronic apparatus was used, and in the “barometric-altitude measurement in related art,” a temperature sensor incorporated in the wrist-worn-type electronic apparatus was used.

(6) After the calibration in (2) described above, no calibration was performed until the summit of the mountain was reached. The altitude h was determined on the basis of the conversion equation (1) by using the electronic apparatus in the “Embodiment” and “Related art,” and errors in the two types of barometric-altitude measurement were calculated on the basis of the calculated altitude h.

On the plurality of mountains that differ from one another in terms of altitude of the summit, the errors in the barometric-altitude measurement in the present embodiment are smaller than the errors in the barometric-altitude measurement in related art, as shown in FIG. 12.

Table 3 shows tabulated representation of the experimental data shown in FIG. 12.

TABLE 3

| | Present | Related |
|---|---|---|
| | embodiment | art |
| Mt. To | 9.5 | 63.0 |
| Mt. Tateshina | 12.6 | 43.0 |
| Mt. Kai-koma | 11.0 | 59.0 |
| Mt. Jonen | 38.3 | 88.0 |
| Mt. Fuji | 26.0 | 45.0 |
| Mt. Takao | 1.7 | 8.0 |
| (Average) | 26.4 | 48.9 |

The average of the errors in the barometric-altitude measurement in related art is 48.9 [m], whereas the average of the errors in the barometric-altitude measurement in the present embodiment is 26.4 [m], as shown in Table 3.

Since the calibration of the barometric-altitude measurement in related art uses the output from a temperature sensor, in particular, the output from a temperature sensor incorporated in a wrist-worn-type electronic apparatus, the calibration is affected by the user's body temperature. It is therefore believed that the calibration of the barometric-altitude measurement in related art was greatly affected by an error in the air temperature. It therefore appears that the error in the barometric-altitude measurement in related art was large.

On the other hand, the calibration of the barometric-altitude measurement in the present embodiment, which uses data memorized in advance in the memory 130, is not affected by the user's body temperature. It is therefore believed that the calibration of the barometric-altitude measurement in the present embodiment was not greatly affected by an error in the air temperature. It therefore appears that the error altitude in the barometric-altitude measurement in the present embodiment was suppressed to a small value.

For reference, Table 4 shows an example of the air temperature error produced by temperature sensors incorporated in wrist-worn-type electronic apparatus. Table 4 shows a true air temperature (actual air temperature) [° C.] at the summit of a certain mountain and temperatures [° C.] detected with temperature sensors.

TABLE 4

| | |
|---|---|
| Actual temperature [° C.] | 4.3 |
| Air temperature measured with | 16 |
| temperature sensor in first | |
| electronic apparatus [° C.] | |
| Air temperature measured with | 22 |
| temperature sensor in second | |
| electronic apparatus [° C.] | |
| Air temperature measured with | 23 |
| temperature sensor in third | |
| electronic apparatus [° C.] | |

### Supplementary Description of Embodiment

The air temperatures stored in the air temperature tables 132A and 132B are sea-level air temperatures T₀ in the present embodiment and may instead be air temperatures T₀′ at predetermined altitude. The air temperature at the predetermined altitude can be converted into the air temperature at another predetermined altitude by using the known conversion equation based on the air temperature lapse rate of 0.0065.

The processing device 120 in the present embodiment uses the difference between the barometric-sensor altitude h and the GPS altitude h_{g} as an index for evaluating whether or not the calibration needs to be performed in step S13, but another index may be used. Further, in addition to the index in the form of the difference, an index representing the reliability of the GPS altitude h_{g} may be used. In general, it is desirable to use an index representing a change in the weather at the point where the electronic apparatus 1 is present.

The processing device 120 in the present embodiment sets the timing at which the calibration is performed in step S13 to be the timing at which the calibration needs to be performed, and the calibration may instead be performed after a predetermined period (for example, one hour or two hours, for example) elapses since the preceding calibration or when the user inputs a calibration instruction.

When the calibration is performed at predetermined intervals, the evaluation step S13 in FIG. 11 may be carried out before step S11, in which actual measured data is referred to, is carried out.

The equation used to in the barometric-altitude measurement or the equation used in the calibration is not limited to the equation described above and may be any known equation. For example, an approximation may be used to suppress the computation burden, or an equation close to the principle of the barometric-altitude measurement may be used to increase the accuracy.

The memory 130 in the present embodiment stores air temperature tables associated with a single local area and may instead memorize in advance air temperature tables associated with two or more local areas (air temperature tables on a local area basis). In this case, the calibrator 123 may use the air temperature tables on a local area basis in accordance with which local area the point where the electronic apparatus 1 is present belongs to. For example, in a case where the memory 130 memorizes air temperature tables associated with Asia and air temperature tables associated with North America in advance, when the point where the electronic apparatus 1 is present belongs to Asia, the air temperature tables associated with Asia may be used, whereas when the point where the electronic apparatus 1 is present belongs to North America, the air temperature tables associated with North America may be used. When the point where the electronic apparatus 1 is present belongs to an area other than Asia or North America, the coefficient table may be used.

A second-order polynomial is used as the polynomial for calculating the air temperature from the latitude in the present embodiment, and the polynomial may instead be a first-order polynomial, a third-order polynomial, or a polynomial having an order greater than three. The higher the order of the polynomial, the larger the amount of data in the coefficient table 133 but the higher the accuracy in the air temperature estimation (because the number of coefficients increases), whereas the lower the order of the polynomial, the lower the accuracy in the air temperature estimation but the smaller the amount of data in the coefficient table 133 (because the number of coefficients decreases).

The calibrator 123 in steps S22, S23, and S24 in the present embodiment corrects the air temperature in accordance with whether or not the current hour and minute fall within the daytime period. Instead, one of the coefficients (zeroth-order coefficient c) of the polynomial for calculating the air temperature may be corrected instead of correction of the air temperature.

In the present embodiment, the amount of correction by which the air temperature is corrected in accordance with whether or not the current hour and minute fall within the daytime period is a predetermined value (see S23 and S24). Instead, the amount of correction may be adjusted in accordance with the number of the current month.

The memory 130 stores the two air temperature tables, the daytime air temperature 132A and the nighttime air temperature 132B, in the present embodiment and may instead store one air temperature table used in both daytime and nighttime. In this case, the calibrator 123 may correct, in accordance with whether or not the current hour and minute fall within the daytime period, the air temperature calculated on the basis of the air temperature table.

The memory 130 stores the single coefficient table used in both daytime and nighttime in the present embodiment and may instead store two coefficient tables, a daytime coefficient table and a nighttime coefficient table. In this case, the calibrator 123 may use the two coefficient tables in accordance with whether or not the current time falls within the daytime period.

The calibration tables stored in the memory 130 are both the air temperature tables and a coefficient table in the present embodiment and may instead be one of the air temperatures or the coefficient table. When the calibration tables stored in the memory 130 are formed only of the air temperature tables, steps S14, S21, S22, S23, and S24 in FIG. 11 are omitted, whereas when the calibration tables stored in the memory 130 are formed only of the coefficient table, steps S14, S15, S16, and S17 in FIG. 11 are omitted.

### Advantageous Effects of Embodiment

(1) The electronic apparatus 1 according to the present embodiment includes the barometric sensor 112, which detects the barometric pressure, the receiver (GPS sensor 110) that receives a positioning signal (GPS signal) from a positioning satellite (GPS satellite), the memory 130, which memorizes in advance information (air temperature table, coefficient table) representing the relationship between the latitude and the air temperature, and the processor (processing device 120) that uses the barometric pressure, the latitude calculated on the basis of the positioning signal (GPS signal), and the information (air temperature table, coefficient table) to calculate the altitude (barometric-sensor altitude).

Since the memory 130 memorizes in advance the information (air temperature table, coefficient table) representing the relationship between the latitude and the air temperature, the processor (processing device 120) can reflect the air temperature determined from the information and the latitude in the barometric-altitude measurement without network connection, user input, or air temperature measurement. The electronic apparatus 1 can therefore suppress a decrease in accuracy in the barometric-altitude measurement even in a situation in which network connection, user input, or air temperature measurement is not allowed.

Therefore, for example, the processor (processing device 120) can perform the calibration of the conversion from the barometric pressure into the altitude (barometric-altitude measurement) at appropriate timing (for example, timing when the weather changes by an amount lager than a fixed amount) or at an appropriate frequency (for example, a frequency higher than the frequency of the change in the weather) to suppress a decrease in accuracy in the barometric-altitude measurement performed by the electronic apparatus 1.

(2) In the electronic apparatus 1 according to the present embodiment, the information (air temperature table, coefficient table) contains at least one of the air temperature tables 132A, 132B, each of which stores air temperatures on a latitude basis, and coefficients of a polynomial (coefficient table 133) that represents the relationship between the latitude and the air temperature.

When the memory 130 memorizes the information in the form of the air temperature tables 132A and 132B, the processor (processing device 120) can readily calculate the air temperature only by referring to the air temperature tables 132A and 132B in accordance with the latitude.

Further, when the memory 130 memorizes the information in the form of the coefficients (coefficient table 133), the processor (processing device 120) can readily calculate the air temperature only by applying the latitude to a polynomial identified by the coefficients (coefficient table 133).

The greater the number of sets of data on the air temperatures stored in the air temperature tables 132A and 132B, the larger the amount of data in the air temperature tables 132A and 132B that occupies the memory 130, but the accuracy in the calculation of the air temperature based on the air temperature tables 132A and 132B can be improved.

Further, the higher the order of the polynomial, the larger the amount of data on the coefficients (coefficient table 133) that occupies the memory 130, but the accuracy in the calculation of the air temperature based on the coefficients (coefficient table 133) can be improved.

T₀ improve the accuracy in the calculation of the air temperature based on the air temperature tables 132A and 132B, it is necessary to increase the amount of data in the air temperature tables 132A and 132B. However, limiting the area to which the air temperature tables 132A and 132B are applied allows improvement in the calculation accuracy with a small amount of data.

On the other hand, since it is not necessary to greatly increase the amount of data on the coefficients (coefficient table 133) in order to improve the accuracy in the calculation of the air temperature (specifically, increasing the order of the polynomial by one only increases the number of coefficients by one), the coefficients (coefficient table 133), which have a small amount of data, are suitably used to cover a wide area. Therefore, for example, even a case where the memory 130 has a small amount of capacity and cannot therefore memorize data on a large number of points can also be handled.

(3) In the electronic apparatus 1 according to the present embodiment, the information (air temperature table, coefficient table) contains the air temperature tables 132A and 132B, each of which stores air temperatures on a latitude basis in a predetermined zone (local area), and the coefficients (coefficient table 133) of a polynomial representing the relationship between the latitude and the air temperature in a zone (global area) containing at least a zone different from the predetermined zone, and when the position calculated on the basis of the positioning signal falls within the predetermined zone (local area) (Y in S14), the processor (processing device 120) uses the air temperature tables 132A and 132B to calculate the altitude (S16, S17), whereas when the position does not fall within the predetermined zone (local area) (N in S14), the processor (processing device 120) uses the coefficients (coefficient table 133) to calculate the altitude (S21).

The processor (processing device 120) uses the air temperature tables 132A, 132B and the polynomial coefficients (coefficient table 133) in accordance with whether or not the position where the electronic apparatus 1 is present falls within the predetermined zone (local area). The electronic apparatus 1 can therefore perform flexible barometric-altitude measurement in accordance with the position where the electronic apparatus 1 is present.

For example, when the position falls within the predetermined zone (local area), the processor (processing device 120) uses the air temperature tables 132A and 132B for calculating the air temperature in the predetermined zone (local area) with high accuracy, whereas when the position does not fall within the predetermined zone (local area), the processor (processing device 120) uses the coefficients (coefficient table 133), which have a small amount of data, for calculating the air temperature in a zone (global area) containing a zone different from the predetermined zone (local area). In this case, the electronic apparatus 1 can not only ensure a wide zone where a decrease in accuracy in the barometric-altitude measurement is suppressed with the capacity of the memory 130 suppressed but also strongly suppress particularly a decrease in accuracy in the barometric-altitude measurement in part of the zone.

(4) In the electronic apparatus 1 according to the present embodiment, the memory 130 memorizes the information on a period basis (every month), and the processor (processing device 120) uses the information in a period within which the current time falls out of the information on a period basis to calculate the altitude.

The memory 130 memorizes the information on a period basis, and the processor (processing device 120) uses the information on a period basis in accordance with the current time. The electronic apparatus 1 can therefore suppress a decrease in accuracy in the barometric-altitude measurement irrespective of variation in the air temperature over different periods (variation over four seasons and different months).

(5) In the electronic apparatus 1 according to the present embodiment, the information contains daytime information representing the relationship between the latitude and the daytime air temperature (air temperature table 132A) and nighttime information representing the relationship between the latitude and the nighttime air temperature (air temperature table 132B), and when the current time falls within the daytime, the processor (processing device 120) uses the daytime information to calculate the altitude, whereas when the current time does not fall within the daytime, the processor (processing device 120) uses the nighttime information to calculate the altitude (S15, S16, and S17).

The processor (processing device 120) uses the daytime air temperature table 132A and the nighttime air temperature table 132B in accordance with whether or not the current time falls within the daytime (S15). The electronic apparatus 1 can therefore perform the barometric-altitude measurement in consideration of the difference between the daytime air temperature and the nighttime air temperature.

Specifically, the electronic apparatus 1 can suppress a decrease in accuracy in the barometric-altitude measurement in both the case where the current time falls within the daytime and the case where the current time falls within the nighttime.

(6) In the electronic apparatus 1 according to the present embodiment, the processor (processing device 120) corrects, in accordance with whether or not the current time falls within the daytime, the information or an air temperature calculated by using the information (S23, S24).

The processor (processing device 120) corrects, in accordance with whether or not the current time falls within the daytime, the information or an air temperature calculated by using the information (coefficients of polynomial or air temperature calculated by using polynomial). The electronic apparatus 1 can therefore perform the barometric-altitude measurement in consideration of the difference between the daytime air temperature and the nighttime air temperature even when the memory 130 separately memorizes the information (coefficients) for the daytime and the information (coefficients) for the nighttime.

Specifically, the electronic apparatus 1 can suppress a decrease in accuracy in the barometric-altitude measurement in both the case where the current time falls within the daytime and the case where the current time falls within the nighttime.

(7) In the electronic apparatus 1 according to the present embodiment, the polynomial is a second-order polynomial.

The number of coefficients of a second-order polynomial is typically “3”. The memory 130 therefore only needs to memorize three coefficients as the information.

(8) In the electronic apparatus 1 according to the present embodiment, the processor (processing device 120) evaluates whether or not the current time falls within the daytime by using the sunrise time and the sunset time (S15, S22).

Since the processor (processing device 120) uses the sunrise time and the sunset time, the processor (processing device 120) can accurately evaluate whether or not the current time falls within the daytime. The electronic apparatus 1 can therefore perform the barometric-altitude measurement in consideration of an effect of the solar movement on the air temperature.

(9) In the electronic apparatus 1 according to the present embodiment, the processor (processing device 120) includes the converter 122, which converts the barometric pressure into the altitude, and the calibrator 123, which calibrates the converter by using the information and the latitude calculated on the basis of the positioning signal.

The calibrator 123 uses the information and the latitude calculated on the basis of the positioning signal to calibrate the converter 122, which converts the barometric pressure into the altitude, (calibrate barometric-altitude measurement). The electronic apparatus 1 can therefore suppress a decrease in accuracy in the barometric-altitude measurement by increasing the accuracy in the calibration on the basis of the information.

(10) The electronic apparatus 1 according to the present embodiment is a mobile electronic apparatus.

The electronic apparatus 1 according to the present embodiment is a mobile electronic apparatus. Therefore, even when a temperature sensor is incorporated in the electronic apparatus, it is difficult to accurately measure the air temperature at the point where the electronic apparatus 1 is present because the temperature sensor is affected by the user's body temperature. However, since the processor (processing device 120) uses the information memorized in the memory 130 in advance instead of a temperature sensor, the air temperature can be calculated without being affected by the body temperature. The electronic apparatus 1, even though it is a mobile electronic apparatus, can therefore perform the barometric-altitude measurement without being affected by the user's body temperature.

### 4. Other Variations

The invention is not limited to the embodiment described above, and a variety of variations are conceivable within the scope of the substance of the invention. In the following description, elements having the same basic functions as those of the elements described in the embodiment have the same reference characters and will not be described.

For example, in the embodiment described above, part of the function of the server 4 may be incorporated in the information terminal 2 or the electronic apparatus 1, or part of the function of the information terminal 2 or the electronic apparatus 1 may be incorporated in the server 4. Further, in the embodiment described above, part or entirety of the function of the electronic apparatus 1 may be incorporated in the information terminal 2, or part or entirety of the function of the information terminal 2 may be incorporated in the electronic apparatus 1.

The electronic apparatus 1 or the information terminal 2 may incorporate known functions of a smartphone, such as a camera function, a call function, an action sensing function (for example, acceleration sensor, angular velocity sensor, and other types of inertia sensors), and a biological activity sensing function (for example, a humidity sensor and a pulse sensor).

The electronic apparatus 1 or the information terminal 2 can be configured as a wrist-worn-type electronic apparatus, an earphone-type electronic apparatus, a finger-ring-type electronic apparatus, a pendant-type electronic apparatus, an electronic apparatus attached to a sport gear for use, a smartphone, a head mounted display (HMD), and a variety of other types of mobile information apparatus.

Examples of application of the electronic apparatus 1 or the information terminal 2 may include skiing (including cross-country skiing and ski jumping), running, bicycling, walking, tennis, swimming, dieting, rehabilitation as well as mountain climbing, and even skating, golf, baseball, soccer, motorcycling, motorsport, boating (speedboat race), sailing, trail running, paragliding, kite flying, dogsledding, robot flying (radio control), and navigation.

The electronic apparatus 1 or the information terminal 2 described above may notify the user of information in the form of image display, audio output, vibration, or any other type of action or a combination of at least two of the image display, audio output, and vibration.

In the embodiment described above, a GPS (global positioning system) is used, and a global navigation satellite system (GNSS) may instead be used. For example, one of or two or more of EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and other satellite positioning systems may be used. Further, WAS (Wide Area Augmentation System), EGNOS (European Geostationary-Satellite Navigation Overlay Service), or any other satellite-based augmentation system (SBAS) may be used as at least one of the satellite positioning systems.

The embodiment and the variations described above are presented by way of example, and the invention is not limited thereto. For example, the embodiment and any of the variations can be combined with each other as appropriate.

The invention encompasses substantially the same configuration as the configuration described in the embodiment (for example, a configuration having the same function, using the same method, and providing the same result or a configuration having the same purpose and providing the same effect). Further, the invention encompasses a configuration in which an inessential portion of the configuration described in the embodiment is replaced. Moreover, the invention encompasses a configuration that provides the same advantageous effects as those provided by the configuration described in the embodiment or a configuration that can achieve the same purpose as that achieved by the configuration described in the embodiment. Further, the invention encompasses a configuration in which a known technology is added to the configuration described in the embodiment.

What is claimed is:

1. An electronic apparatus comprising:
a barometric sensor that detects barometric pressure;
a receiver that receives a positioning signal from a positioning satellite;
a memory that memorizes in advance information representing a relationship between latitude and air temperature; and
a processor that uses the barometric pressure, latitude calculated based on the positioning signal, and the information to calculate altitude.

2. The electronic apparatus according to claim 1,
wherein the information contains at least one of
an air temperature table that stores air temperatures on a latitude basis, and
coefficients of a polynomial that represents the relationship between the latitude and the air temperature.

3. The electronic apparatus according to claim 1,
wherein the information contains
an air temperature table that stores air temperatures on a latitude basis in a predetermined zone, and
coefficients of a polynomial that represents the relationship between the latitude and the air temperature in a zone containing at least a zone different from the predetermined zone, and
when a position calculated based on the positioning signal falls within the predetermined zone, the processor uses the air temperature table to calculate the altitude, whereas when the position does not fall within the predetermined zone, the processor uses the coefficients to calculate the altitude.

4. The electronic apparatus according to claim 1,
wherein the memory memorizes the information on a period basis, and
the processor uses the information in a period within which current time falls out of the information on a period basis to calculate the altitude.

5. The electronic apparatus according to claim 1,
wherein the information contains daytime information representing a relationship between the latitude and daytime air temperature and nighttime information representing a relationship between the latitude and nighttime air temperature, and
when current time falls within the daytime, the processor uses the daytime information to calculate the altitude, whereas when the current time does not fall within the daytime, the processor uses the nighttime information to calculate the altitude.

6. The electronic apparatus according to claim 1,
wherein the processor corrects, in accordance with whether or not current time falls within daytime, the information or an air temperature calculated by using the information.

7. The electronic apparatus according to claim 2,
wherein the polynomial is a second-order polynomial.

8. The electronic apparatus according to claim 5,
wherein the processor evaluates whether or not the current time falls within the daytime by using sunrise time and sunset time.

9. The electronic apparatus according to claim 1,
wherein the processor includes
a converter that converts the barometric pressure into the altitude, and
a calibrator that calibrates the converter by using the information and the latitude calculated based on the positioning signal.

10. The electronic apparatus according to claim 1,
wherein the electronic apparatus is a mobile electronic apparatus.

11. An altitude calculation method comprising:
detecting barometric pressure;
receiving a positioning signal from a positioning satellite; and
calculating altitude by using the barometric pressure, latitude calculated based on the positioning signal, and information memorized in advance and representing a relationship between latitude and air temperature.
